(19) United States
(12) Patent Application Publication
(10) Pub. No.: US 2004/0070261 A1
(43) Pub. Date: Apr. 15, 2004

(54) Wheel frame for hollow foam wheel

(76) Inventor: Wen-Yao Han, Tainan (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/307,693

(22) Filed: Dec. 2, 2002

(30) Foreign Application Priority Data
Oct. 15, 2002 (TW) 091216317

(51) Int. Cl. B60B 3/10

(52) U.S. Cl. 301/64.201

(57) ABSTRACT

A wheel frame for a hollow foam wheel includes a hollow foam tire which has two opposing bulged inner rims to form a housing space therebetween, two opposing wheel frames located on two outer sides of the foam tire each having a jutting outer rim. The jutting outer rim has an inner side with spikes located thereon and an inner peripheral surface which has first ridges formed thereon. The housing space holds a plurality of retaining members assembled in an annular manner. Each retaining member has a flange on the inner rim thereof with second ridges formed on the inner peripheral surface to mate alternately the first ridges of the wheel frame. The two wheel frames are screwed towards each other to clamp the foam tire securely between the jutting outer rim and the retaining members. The spikes on the inner side of the wheel frame pierce into the foam tire for anchoring. Thus the hollow foam tire may be coupled and anchored securely and provide an improved elastic and cushion effect.

### BACKGROUND OF THE INVENTION

1. Field of the Invention

The invention relates to a foam wheel and particularly a wheel frame for a foam wheel that has two wheel frames sandwiching a retaining member for clamping tightly two opposing bulged inner rims of a hollow foam tire to fasten the foam tire securely on the wheel frames to provide improved elasticity and cushion effect.

2. Description of the Prior Art

As show issued no.358425 patent in FIGS. 1 and 2, Conventional foam wheels generally have a solid structure. While the material of the solid tire has certain elasticity, in order to support a heavier weight and prevent the tire from occurring deformation under pressure, the tire must not be too soft or pliable. Hence the tire generally is made from a material with a high degree of hardness. As a result, it has a lower elasticity and smaller cushion effect.

In order to enable the foam tire to be mounted onto the wheel frame in a hollow fashion, there is a conventional wheel structure as shown issued no.358425 patent in FIGS. 3, 4 and 5. For manufacturing the wheel, after the required elements are made, they are assembled to form a completed wheel frame 60. Then the wheel frame 60 is placed in a mold, and blank material is poured into the mold to blow and directly form a foam tire 40 on the wheel frame 60. The foam tire 40 is coupled on a first and a second wheel frame 61 and 62, and has a hollow interior. As the first and the second wheel frame 61 and 62 are made from hard plastics, after the hollow interior of the foam tire encases the hard wheel frame, the foam tire loses the elasticity and pliability originally existed on the hollow foam tire.

Thus the conventional structure set forth above not only fails to take the advantages of the elasticity and pliability of the material of the foam tire, it makes the foam tire even harder and losing its inherent cushion capability. Moreover, the fabrication process of forming the foam tire directly on the wheel frame requires molds that are difficult to design and is more costly.

### SUMMARY OF THE INVENTION

In view of the aforesaid disadvantages, the object of the invention is to provide an improved hollow foam wheel structure that has two opposing wheel frames. Each of the wheel frames has a jutting outer rim and a jutting inner rim. A plurality of retaining members is assembled in an annular manner. The retaining member has a wider flange on the inner rim. The foam tire has two opposing bulged inner rims to be clamped between the jutting inner rim of the wheel frame and the flange of the retaining member to form a secured coupling on the wheel frame. The foam wheel thus made has an improved elasticity and cushion effect.

In addition, the jutting outer rim of the wheel frame has an inner convex side with spikes located thereon to pierce into the foam tire during coupling. Such a design and structure forms an anchoring effect and can prevent the foam tire from slipping on the wheel frame.

Moreover, the outer peripheral surface of the jutting inner rim of the wheel frame has first ridges former thereon, and the inner peripheral surface of the flange of the retaining member also has second ridges formed thereon to mate the first ridges alternately. Such a design also forms an anchoring effect and prevents the foam tire from slipping on the wheel frame.

Furthermore, the retaining members that are assembled in an annular manner have carved and spaced openings on the lateral side to allow the bulged inner rim of the foam tire to wedge in to form a secured anchoring between the foam tire and the retaining members.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the foam wheel of the invention.

FIG. 2 is a fragmentary sectional view of the foam wheel of the invention.

FIG. 3 is a schematic view of a conventional foam wheel.

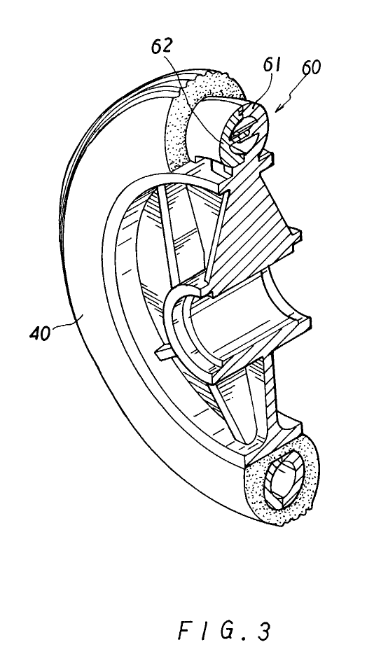

### DESCRIPTION OF THE PREFERRED EMBODIMENT

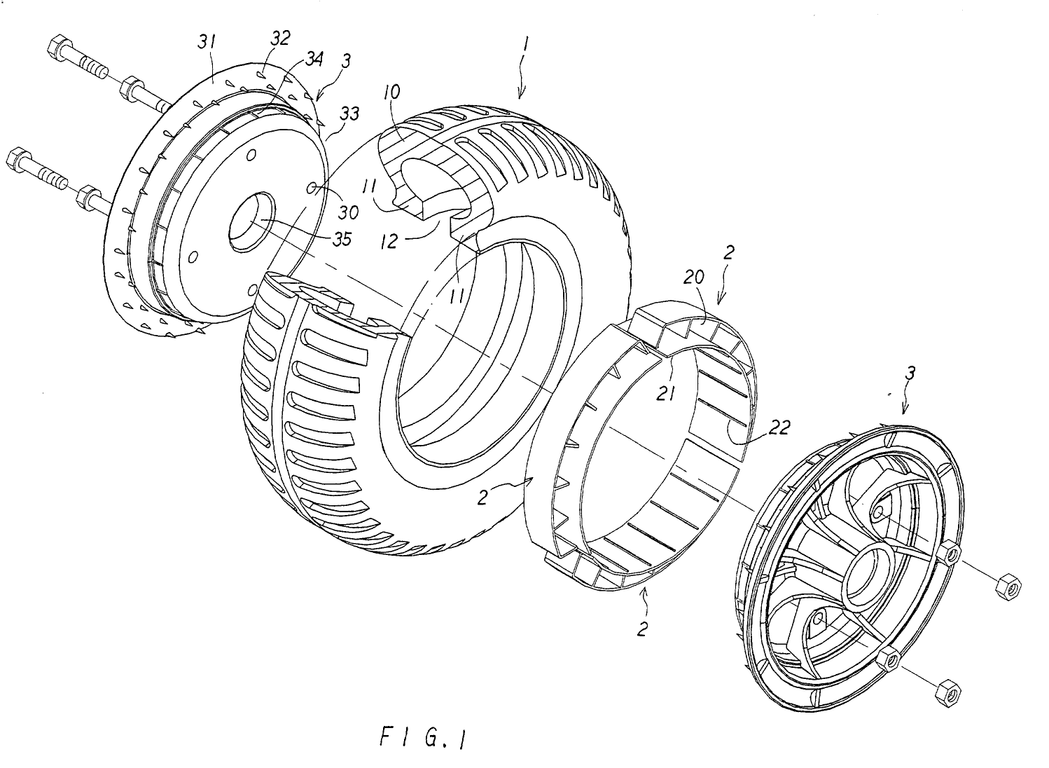

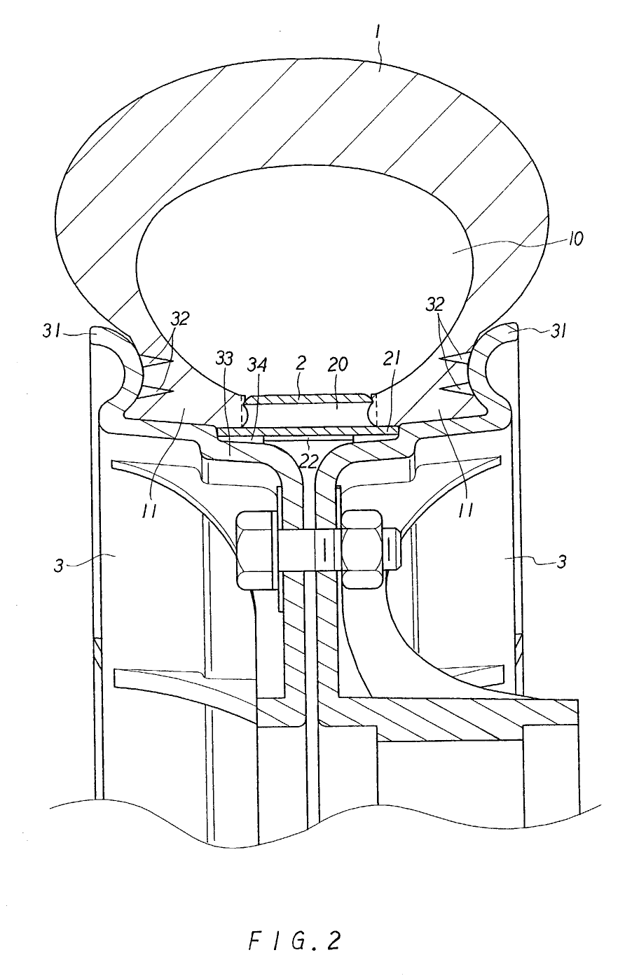

Referring to FIGS. 1 and 2, the foam wheel of the invention includes two opposing wheel frames 3 and a plurality of retaining members 2 assembled in an annular manner and located between the wheel frames 3 to sandwich and clamp a foam tire 1 therebetween.

The foam tire 1 is hollow and has two bulged inner rims 11 and a housing space 12 located between the bulged inner rims 11.

The retaining members 2 are assembled in an annular manner and are located in the housing space 12 of the foam tire 1 between the two opposing bulged inner rims 11. Each of the retaining members 2 has carved and spaced openings 20 formed on the lateral side, and an inner rim forming a wider flange 21. The flange 21 has two sides located below the bulged inner rims 11 of the foam tire 1. The flange 21 has an inner peripheral surface with a plurality of spaced second ridges 22 formed thereon.

The two opposing wheel frames 3 are located on two outer sides of the foam tire 1, and have an axle hole in the center to house an axle (not shown in the drawings). Each of the wheel frames 3 has an arched and jutting outer rim 31 which has a convex inner side with a plurality of spikes 32 located thereon. Each wheel frame 3 further has a jutting inner rim 33 which has an outer peripheral surface with a plurality of first ridges 34 formed thereon.

For assembly, the foam tire 1 is sandwiched between the two opposing wheel frames 3. The jutting inner rims 33 are wedged in the foam tire 1 and the jutting outer rims 31 flank the outer sides of the bulged inner rims 11 of the foam tire 1. The retaining members 2 are located in the housing space 12 between the two bulged inner rims 11. The flange 21 of the retaining members 2 is extended above the jutting inner rim 33 of the wheel frames 3. The second ridges 22 and the first ridges 34 mate one another alternately. Then the two opposing wheel frames 3 are screwed towards each other to tightly clamp the bulged inner rim 11 of the foam tire 1 between the jutting outer rim 31 of the wheel frames 3 and the retaining members 2. Meanwhile, the spikes 32 on the surface of the jutting outer rim 31 pierce into the foam tire 1, and the bulged inner rims 11 of the foam tire 1 in contact with the lateral side of the retaining members 2 are compressed and wedged in the carved openings 20 on the lateral side of the retaining members 2. Thus the foam tire 1, in addition to being clamped for anchoring, also is retained and anchored by the spikes 32 and the carved openings 20. Hence the foam tire 1 is wedged and anchored securely between the wheel frames 3 and the retaining members 2 without slipping. The first ridges 34 on the peripheral surface of the jutting inner rim 33 of the wheel frame 3 and the second ridges 22 on the inner peripheral surface of the retaining members 2 also compress the foam tire 1 to provide an anchoring effect and prevent the foam tire 1 from slipping between the wheel frames 3 and the retaining members 2.

By means of the construction set forth above, the hollow foam tire can be mounted and anchored securely on the wheel frames without slipping. And the hollow foam tire also can provide elastic and effective cushion effect.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

I claim:

1. A wheel frame for a hollow foam wheel, comprising:
a hollow foam tire having two opposing bulged inner rims to form a housing space therebetween;
two opposing wheel frames located on two outer sides of the foam tire each having a jutting outer rim and a jutting inner rim; and
a plurality of retaining members assembled in an annular manner and located in the housing space, each retaining member having a flange formed on an inner rim thereof for extending below the bulged inner rims of the foam tire;
wherein the two wheel frames are screwed towards each other to clamp securely the bulged inner rims of the foam tire between the jutting outer rims and the retaining members for anchoring the foam tire on the wheel frames and providing an improved elastic and cushion effect.

2. The wheel frame for a hollow foam tire of claim 1, wherein the jutting outer rim of the wheel frame has an arched and convex inner side.

3. The wheel frame for a hollow foam tire of claim 1, wherein the jutting outer rim of the wheel frame has an inner side which has spikes located thereon for piercing into the foam tire.

4. The wheel frame for a hollow foam tire of claim 1, wherein the wheel frame has an inner peripheral surface which has first ridges formed thereon, the retaining member having an inner peripheral surface which has second ridges formed thereon to mate the first ridges alternately.

5. The wheel frame for a hollow foam tire of claim 1, wherein each of the retaining members has carved and spaced openings formed on the lateral side thereof to allow the bulged inner rims of the foam tire to wedge in for anchoring purpose.
